(19) United States
(12) Patent Application Publication
(10) Pub. No.: US 2009/0095809 A1
(43) Pub. Date: Apr. 16, 2009

(54) METHOD OF TRANSMITTING A SECRET CODE, CARD READING TERMINAL, MANAGEMENT SERVER AND CORRESPONDING COMPUTER SOFTWARE PROGRAMMES

(75) Inventor: David Naccache, Paris (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: COMPAGNIE INDUSTRIELLE ET FINANCIERE D'INGENIERIE "INGENICO", Neuilly Sur Seine (FR)

(21) Appl. No.: 12/250,341

(22) Filed: Oct. 13, 2008

(30) Foreign Application Priority Data
Oct. 12, 2007 (FR) 07/58294

(51) Int. Cl. G06K 5/00

(52) U.S. Cl. 235/380

(57) ABSTRACT

A method and apparatus are provided for transmitting a secret code of a new microprocessor card held by a user. The method includes: insertion by the user of the new card into a card reading terminal; sending a request to obtain the secret code by the card reading terminal to a management server; and transmission by the management server, via a communication network, of the secret code or of an item of information permitting the secret code to be obtained, to a communication terminal of the user.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure concerns the field of microprocessor cards, which require a secret code to be supplied to enable them to be used.

More precisely, the disclosure concerns the transmission of this secret code to a user of a new card.

The disclosure thus applies to the techniques according to which a new card is supplied to the user independently of its secret code, for security reasons. This may for example concern payment cards supplied by banking organizations.

### BACKGROUND OF THE DISCLOSURE

Microprocessor cards, called chip cards, are known and are today widely used. When a chip card is used as a payment card, the authorized user or the holder of the chip card, who we will subsequently call “the user”, may use it for example to purchase goods or withdraw cash from an automatic cash dispenser (ATM).

The banking organizations (emitter) regularly send their clients, for example every two years, a new payment card that is designed to replace their current payment card (former card).

Before sending it, each new payment card is personalized so that information may be stored on it which allow it to be used by the user. This involves both authentication data that is specific to the emitter of the card and information for identifying and authenticating the user (name, card number, validity date, etc). A new payment card is sent in a known manner by post to its user or a branch of a bank wherein the user may collect it.

Payment cards are generally used with a secret code. The associated secret code to the payment card is, in general, generated by the organization that personalizes the card. In a known manner, a new secret code, associated to a new payment card, is sent in a secure letter called a mailer, whose features prevent anyone from reading the secret code by transparency or opening the mailer without leaving any irreversible traces.

The letter containing the new payment card and the mailer are not sent at the same time so as to reduce the risk that a malicious person could intercept both the payment card and the associated secret code.

This approach is of course not restricted to payment cards, but also applies to most systems that use chip cards, for example to authenticate the user, to access a service, or premises.

One disadvantage is that the printing and the sending of a mailer generates costs for the emitter of the payment card that would be preferably minimized. Indeed, this mailer generally comprises a special paper with several thicknesses, a protective flap covering the zone where the code is written, perforated sections, etc.

Furthermore, there is a risk that a malicious person could succeed in recovering the mailer sent by the post.

Another disadvantage of this separate transmission is that the user depends on the postal transfer times and has to wait for the mailer before the new payment card may be used.

### SUMMARY

An aspect of the disclosure relates to a method of transmitting a secret code of a new microprocessor card held by a user.

According to an aspect of the disclosure, said method comprises the following steps:
insertion by said user of said new card in a card reading terminal;
sending of a request to obtain said secret code by said card reading terminal to a management server;
transmission by said management server, via a communication network, of said secret code or of an item of information permitting said secret code to be obtained, to a communication terminal of said user.

Consequently, the method according to an aspect of the disclosure permits a holder of a new payment card to receive the new associated secret code to this card by means of a communication terminal. The transmission of the secret code is initiated by the insertion of the new payment card into a card reading terminal, which may be a payment terminal in a shop.

Such a method avoids the emitting organization having to print and send a mailer for the payment card, minimizes the risks related to the transmission of the secret code to the user of the payment card and is simple and practical for the user and the emitter of the new payment card.

According to a preferred embodiment, the method according to an aspect of the disclosure comprises a step where said user inserts a former card, designed to be replaced by said new card, in a card reading terminal.

The insertion of the former payment card, designed to be replaced by the new payment card, in the payment terminal, thus permits the probability to be reduced that a malicious person, who had intercepted the new payment card, could receive the new associated secret code. Indeed, a holder of a new payment card (the authorized user or a fraud) cannot have the new associated secret code transmitted unless he/she has the former payment card that is to be replaced by the new one.

According to another preferred feature, said step of inserting a former card is required by said card reading terminal, after said step of inserting said new card.

Consequently, the method according to an aspect of the disclosure requires the sequential insertion of the new payment card then the former payment card. Once the former payment card has been inserted in the payment terminal, and possibly once that the secret code associated to this former payment card has been correctly entered on the keypad of the payment terminal, the secret code associated to the new payment card may be transmitted to a communication terminal of the user.

According to a specific embodiment, said transmission step is delayed by a predetermined lapse of time, after receipt of said request to obtain the code.

Consequently, the transmission of the secret code to the user of the new payment card may be delayed so that the user can become familiar with the secret code in complete security in a place other than the shop where the payment terminal is located. This avoids a malicious person from learning the secret code sent without the user's knowledge, while the latter is carrying out the initialization operations (insertion of the new and the former cards).

According to another specific aspect, said secret code or said information which permits said secret code to be obtained is sent in the form of an SMS message, a voice message or an E-mail.

The sending of a mailer is thus replaced by an electronic transmission of the secret code to a communication terminal of the user, which may be a mobile telephone or a computer for example, ensuring rapid and low cost receipt of the secret code by the user.

According to yet another feature, said transmission step comprises an operation for encrypting said secret code or said information permitting said secret code to be obtained.

The encryption of the secret code when it is sent to the user ensures the best possible security and reduces the risk of a malicious person from obtaining the secret code during its transmission to the communication terminal of the user.

According to a specific embodiment, said encryption operation takes into account an identifier of said communication terminal and/or the secret code of said former card.

According to a specific aspect, compatible with the previous ones, the method comprises a step for activating said new card, by said management server.

The method according to an aspect of the disclosure thus includes a step for activating the new payment card by the management server which, as soon as the secret code has been sent to the user, authorizes its use to carry out transactions.

According to another specific aspect, the method comprises a step of deactivating said former card, by said management server and/or by said card reading terminal.

Consequently, following this step, the user or a malicious person may no longer use the former payment card to carry out transactions.

According to a preferred embodiment, the deactivation step is implemented during the first use of said new card.

The deactivation of the former payment card only becomes effective following the first use of the new payment card (therefore from the time that the new code has effectively been received), the user therefore always has an activated payment card that permits him/her to carry out transactions.

According to another aspect, the disclosure concerns a card reading terminal for the implementation of the method of transmitting a secret code of a new microprocessor card held by a user.

According to an aspect of the disclosure, such a card reading terminal comprises:
means of reading and detecting a new card;
means of sending a request to a management server to obtain said secret code.

Consequently, the card reading terminal, which is for example located in a shop or service provider, may detect the presence of a new card and send a request to a management server to obtain the secret code associated to this new card.

According to a preferred embodiment, the card reading terminal according to an aspect of the disclosure comprises means of requesting the insertion of a former card, designed to be replaced by said new card.

According to another aspect, the disclosure concerns a management server for the implementation of the method of transmitting a secret code of a new microprocessor card held by a user.

According to an aspect of the disclosure, such a management server comprises:
means of receiving a request to obtain said secret code sent by a card reading terminal;
means of sending, via a communication network, said secret code or an item of information permitting said secret code to be obtained, to a communication terminal of said user.

Consequently, the management server sends a secret code associated to a new card to a communication terminal of the user in response to the receipt of a request to obtain the secret code by a card reading terminal.

Yet another aspect of the disclosure concerns computer software program that may be downloaded from a communication network and/or stored on a computer readable support and/or executable by a microprocessor, permitting the execution of the corresponding steps respectively in the card reading terminal and the management server.

### BRIEF DESCRIPTION OF THE DRAWINGS

### List of Figures

Other features and advantages of the disclosure will become clearer upon reading the following description of a specific embodiment, provided simply by way of example and in no way restrictively, and the appended drawings, among which:

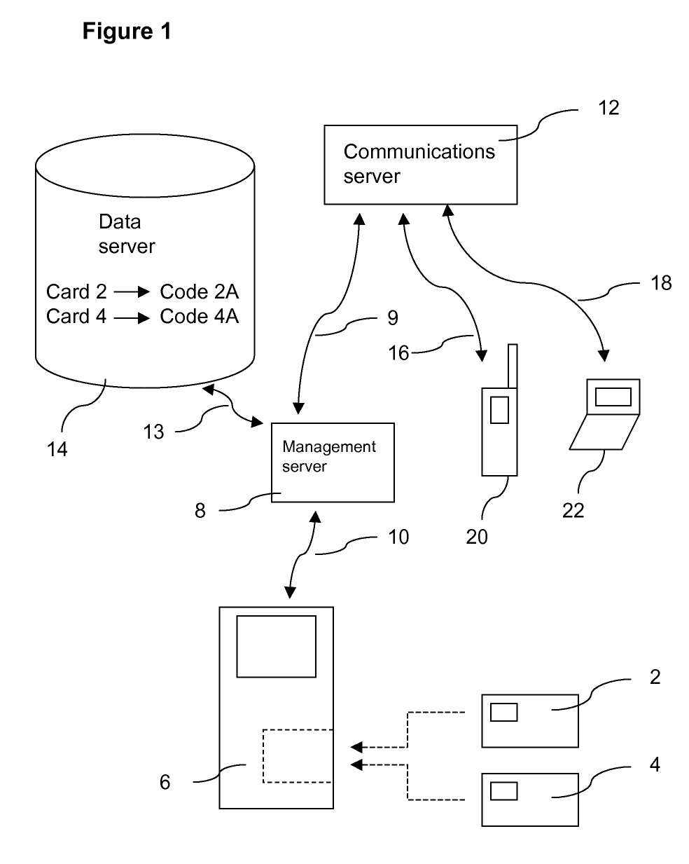

FIG. 1 diagrammatically shows an example of a system implementing a method of transmitting a secret code according to a specific aspect of the disclosure;

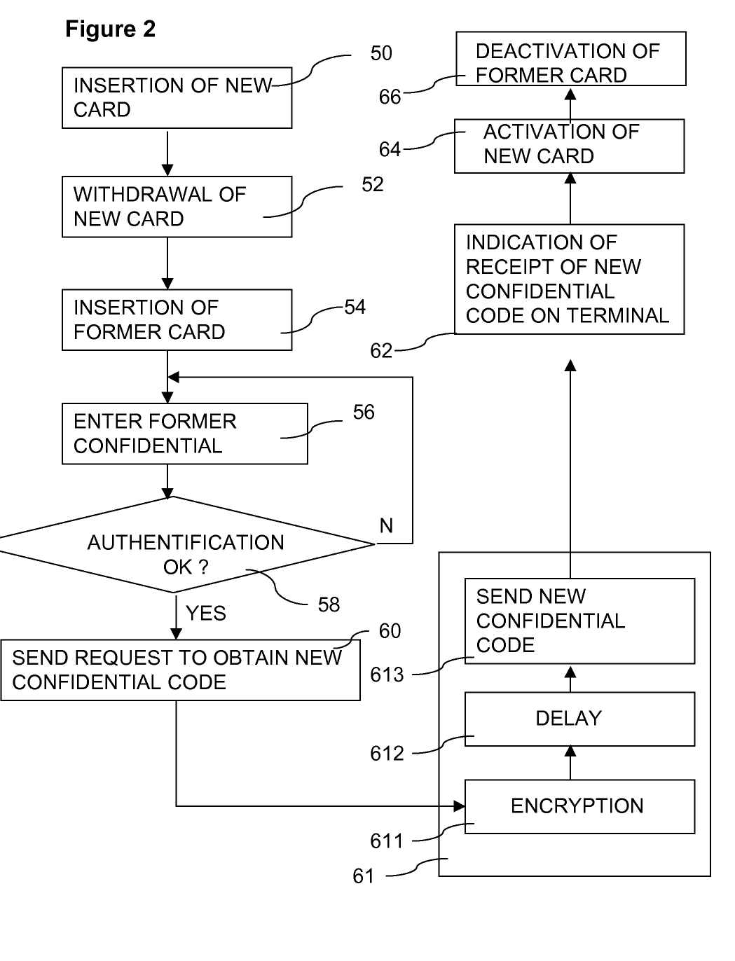

FIG. 2 shows the main steps of the method of transmitting a secret code according to the embodiment of FIG. 1.

### DETAILED DESCRIPTION OF ILLUSTRATIVE EMBODIMENTS

The general principle of an aspect of the disclosure is based on the secure transmission, electronically, of a secret code of a new microprocessor card held by a user.

More precisely, the method of an aspect of the disclosure allows the user to be provided with the secret code associated to his/her new card by means of a communication terminal, for example a digital telephone, following the insertion of the new card in a card reading terminal provided for this purpose.

In particular, such a method permits the transmission of the secret code to the user in the form of an SMS message, a voice message or an E-mail.

Now in relation to FIG. 1, a system is presented which implements such a method according to a specific aspect of the disclosure.

In this example, a user of a new microprocessor card (chip card) 2, for example a new payment card sent by a banking organization (emitter), is considered. The user wishes to activate the new payment card 2 that he/she has previously received, by post or by any other means.

The new payment card 2 is, when received by the user, in a deactivated state. It is designed to replace the former payment card 4, which the user possess and which is activated. By “deactivated” card, in this example, it is meant a card that is not associated to a client of the banking organization and which therefore may not be used to make a payment by means of a payment terminal or withdraw cash from an ATM.

A card reading terminal, which may be a payment terminal 6, is located for example in a shop or with a service provider. The payment terminal 6 is connected to a remote management server 8, managed by a banking organization, via a communication network 10 which permits the exchange of information between the payment terminal 6 and the server 8 of the banking organization.

The remote server 8 of the banking organization further authorizes secure electronic transactions and may be connected to several payment terminals (not shown). The banking organization manages, by means of a data base of a secure data server 14, to which it may access via an access point 13, a list of payment card identifiers. In this data base, each payment card identifier, which is a card number for example, is associated to a secret code and/or data derived from the secret code.

By secret code it is meant for example the personal identification number (PIN) of the holder of a payment card or secret code. The secret code associated to a payment card is generally made up of a series of four digits.

It is supposed in this embodiment that each payment card 2, 4, respectively deactivated and activated, is associated to a distinct secret code, respectively a secret code 2A and a secret code 4A, in the data base of the data server 14. Before the implementation of the method of an aspect of the disclosure, the user of the payment cards 2, 4 only knows the secret code 4A associated to the former payment card 4. The method according to an aspect of the disclosure, which will be detailed in relation to FIG. 2, aims to send the user the secret code 2A associated to the new payment card 2 simply and securely, without the use of a mailer.

The server 8 of the banking organization is connected to a communication server 12 via an access point 9. In this way, a secret code stored in the data base of the data server 14 may be sent from the server 8 of the banking organization to the communication server 12, which may in turn send it to a communication terminal 20, 22 of the user (payment cards 2, 4) by means of a communication network.

The communication network is for example a computer network 16 or a telecommunications network 18. In particular, the secret code 2A may be sent by SMS, or by E-mail.

Preferably, it is sent in a secure form, for example encrypted.

Alternatively, it is not the secret code 2A itself that is sent, but an item of information permitting this secret code 2A to be obtained, for example by combining it according to a predetermined algorithm with the telephone number of the user, the user's account number, a password and/or the former secret code 4A. In this case, the communication terminal 20, 22 is able to extract the secret code 2A from this item of information by applying the inverse algorithm.

The telecommunications network 16 may be based on the GSM (Global System for Mobile Communications), GPRS (Global Packet Radio Service), UMTS (Universal Mobile Telecommunications System) standards or any other standard. The computer network 18 may be the Internet network. These two networks allow the secret code 2A to be sent to the communication terminal 20, 22 of the user by means of an SMS (Short Message Service) message, an MMS (Multimedia Messaging Service) message, an E-mail or a voice message for example.

In this embodiment, the communication terminal 20, 22 on which the client may view the secret code 2A may be a radiotelephone, a pocket computer (a personal assistant for example), a laptop computer, a micro-computer, etc.

In one variant of embodiment, the server 8 of the banking organization and the communication server 12 are integrated into a same management server.

Below in relation to FIG. 2, are presented the main steps of the method of transmitting a secret code according to the above-mentioned aspect of the disclosure.

Firstly, during step 50, the user inserts the new payment card 2 that he/she has received recently into the payment terminal 6 in a shop. The payment terminal 6 is capable or reading and detecting, alone or together with the server 8 of the banking organization, that it is a new deactivated payment card. In return it asks the user, by means of a display screen (not shown) or another interface, for example a voice interface, to remove the new payment card 2 from the payment terminal 6 and to insert the former activated payment card 4, that is designed to be replaced by the new payment card 6.

Once the new payment card 2 has been removed (step 52), and the former payment card 4 inserted in the payment terminal 6 (step 54), the payment terminal 6 may ask the user to enter, by means of the digital keypad (not shown) of the payment terminal 6, the secret code associated to the former payment card 4 (step 56). In a known manner, a check is then made in the payment terminal 6 that the secret code entered into the keypad is correct, in function of secret information (4A) stored on the payment card 4 (step 58).

In the case where the code is correct, the payment terminal 6 sends the remote server 8 of the banking organization, via the communication network 10, a request to obtain the secret code of the new payment card 2 (step 60).

In the case where the server 8 does not recognize the address or the number (which may have been provided for example when the account was opened) to which the new secret code 2A is to be sent, a procedure may be included to allow the user to provide it, possibly with a verification procedure. It may also be provided that the user can state the time that he/she wishes the server 8 to wait before sending the code.

The server 8 comprises means of receiving the request sent by the payment terminal 6. In response to this request, the server 8 recovers the secret code 2A, associated to the new payment card 2, which is stored in the data base of the data server 14. The server 8 of the banking organization then sends the secret code 2A to the communication server 12 which may in turn send it, by means of the computer network 16 or the telecommunications network 18, to the communication terminal 20, 22 of the user (step 61).

The communication terminal 20, 22 may receive a message to advise the user (step 62), that the new secret code 2A may be accessed by the user, or that the transmission is in progress. This may be a visual, sound or tactile message.

The transmission 613 may be secured (611) especially by encrypting and/or delaying (612).

According to one variant, the payment terminal 6 dos not require the secret code associated to the former payment card 4 to be entered, and the method according to an aspect of the disclosure then moves directly from step 54 (insertion of the former payment card 4 into the payment terminal 6) to step 60 (sending of a request to obtain the secret code 2A by the payment terminal 6).

In the following steps 64 and 66, respectively, the new payment card 2 is activated by the server 8 of the banking organization and the former payment card 4 is deactivated by the server 8 of the banking organization and/or by the payment terminal 6, (almost) simultaneously or sequentially.

It is however preferable for the new payment card 2 to be activated prior to the former payment card 4 being deactivated, so that the user always has at least one activated card for obvious practical reasons. Consequently, the former payment card 4 may be deactivated when the new payment card 2 is used for the first time, when the user makes a payment in a shop for example using a payment terminal.

According to one variant of this embodiment, the secret code 2A is sent to the communication terminal 20, 22, of the user, after the server 8 has received the request to obtain the code sent by the payment terminal 6, with a delay (612) by a predetermined lapse of time for security reasons. This delay may possibly be introduced by the user by means of the keypad of the payment terminal 6 or by means of the communication terminal 20, 22.

In this case, the deactivation of the former payment card 4 is delayed by at least this lapse of time.

According to another variant, the method passes to step 66 (deactivation of the former payment card 4) once the message containing the secret code 2A is detected by the communication terminal 20, 22 and/or once the user activates an indicator that the message containing the secret code 2A has been read on the communication terminal 20, 22.

It should also be noted that the deactivation step 66 could alternatively be carried out prior to the transmission step of the new code 61.

According to one variant, an item of information permitting the secret code 2A to be obtained is sent to the communication terminal 20, 22 of the user. In this case, the communication terminal 20, 22 comprises means which permit the secret code 2A to be derived from the information received.

According to another variant, that may or may not be complementary to the previous one, the secret code 2A or the information permitting the secret code 2A to be obtained may be sent to the communication terminal 20, 22 of the user in encrypted form (611). In this case, the secret code 2A or the information permitting the secret code 2A to be obtained may be encrypted with an identifier (telephone number, IP address, etc) of the communication terminal 20, 22 or an identifier of the former payment card 4 (secret code 4A, etc) for example. In this case, the communication terminal 20, 22 comprises means of decoding the message sent that are known to a person skilled in the art.

According to another variant of this embodiment, the method does not include the step of inserting the former payment card 2, and therefore does not require steps 54 to 58 (or steps 52 to 58) of FIG. 2.

It may therefore be envisaged that the payment terminal 6 includes a function that may be activated by a user (a key of the keypad for example) which permits the method of transmitting a secret code to be initiated following the insertion of a new payment card in the payment terminal 6.

It should be noted that the method may be implemented in a payment terminal, or more generally card reading terminal, of the usual type, provided that it uses an adapted computer program, capable of implementing the method described above. This program may be present from the start, in a memory of the terminal, or uploaded during an update, from a support such as a CD-ROM or via a server.

In certain embodiments, it may be provided that the terminal is an appliance dedicated to the initialization of new cards, located for example in a bank branch.

An aspect of the disclosure ensures better security when supplying a user with a new payment card and a new associated secret code to this card.

An aspect of the disclosure minimizes the costs for the user and/or the banking organizations and to improve the security and the simplicity by restricting transmissions by post.

An aspect of the disclosure facilitates the activation of the payment card, while reducing the risk of a malicious person activating the payment card instead and in place of the user.

Although the present disclosure has been described with reference to one or more examples, workers skilled in the art will recognize that changes may be made in form and detail without departing from the scope of the disclosure and/or the appended claims.

1. A method of transmitting a secret code of a new microprocessor card held by a user, wherein the method comprises the following steps:
insertion by said user of said new card into a card reading terminal;
sending a request to obtain said secret code by said card reading terminal to a management server;
transmission by said management server, via a communication network, of said secret code or of an item of information permitting said secret code to be obtained, to a communication terminal of said user.

2. The method according to claim 1, wherein the method further comprises a step of:
insertion by said user of a former card, designed to be replaced by said new card, in the card reading terminal.

3. The method according to claim 2, wherein said step of inserting a former card is required by said card reading terminal, after said step of inserting said new card.

4. The method according to claim 1, wherein said transmission step is delayed by a predetermined lapse of time, following receipt of said request to obtain the code.

5. The method according to claim 1, wherein said secret code or said information permitting said secret code to be obtained is sent in the form of an SMS message, a voice message or an E-mail.

6. The method according to claim 1, wherein said transmission step comprises an operation, which encrypts said secret code or said information permitting said secret code to be obtained.

7. The method according to claim 6, wherein said encryption operation takes account of at least one of an identifier of said communication terminal or of the secret code of said former card.

8. The method according to claim 1, wherein the method comprises a step of:
activating said new card, by said management server.

9. The method according to claim 2, wherein the method comprises a step of:
deactivation of said former card, by at least one of said management server or by said card reading terminal.

10. The method according to claim 9, wherein said deactivation step is implemented during the first use of said new card.

11. A card reading terminal for implementation of a method of transmitting a secret code of a new microprocessor card held by a user, wherein the method comprises:
means of reading and detecting the new card;
means of sending a request to a management server to obtain said secret code.

12. The card reading terminal according to claim 11, wherein the terminal comprises means of requesting insertion of a former card, designed to be replaced by said new card.

13. A management server for implementation of a method of transmitting a secret code of a new microprocessor card held by a user, wherein the method comprises:
means of receiving a request to obtain said secret code sent by a card reading terminal;
means of sending, via a communication network, said secret code or an item of information permitting said code secret to be obtained, to a communication terminal of said user.

14. A computer software program stored on a computer readable support and comprising program code instructions for execution on a card reading terminal of method of transmitting a secret code of a new microprocessor card held by a user, the method comprising:
reading and detecting a new card;
sending a request to obtain said secret code to a management server.

15. A computer software program stored on a computer readable support and comprising program code instructions for execution on a management server of a method of transmitting a secret code of a new microprocessor card held by a user, the method comprising:
receiving a request to obtain said secret code sent by a card reading terminal;
sending, via a communication network, said secret code or an item of information permitting said secret code to be obtained, to a communication terminal of said user.
